(19) United States
(12) Patent Application Publication
(10) Pub. No.: US 2011/0123964 A1
(43) Pub. Date: May 26, 2011

(54) COMPUTERIZED AID FOR PLANNING A NUTRITIONALLY BALANACED MENU

(75) Inventors: Ze'ev Aronis, Petach-Tikva (IL); Anna Aronis, Petach-Tikva (IL)

(73) Assignee: LOGI-DIET LTD., Petach-Tikva (IL)

(21) Appl. No.: 12/626,638

(22) Filed: Nov. 26, 2009

(51) Int. Cl. G09B 19/00

(52) U.S. Cl. 434/127

(57) ABSTRACT

The invention provides a method and system for computerized preparation of a nutritionally balanced food menu. The invention retrieves pre-classified food items from a food item database, to form an initial daily menu. The initial daily menu is interactive, allowing a user to amend the menu to suit his preferences. The invention then automatically rebalances the menu to eliminate nutrient surpluses or deficiencies, and displays the balanced menu to a user.

### FIELD OF THE INVENTION

The invention relates to an aid for maintaining a nutritional diet. Specifically, the invention relates to a method and system for computerized planning of a balanced diet. The invention allows user interaction in planning the diet.

### BACKGROUND

Obesity has a well-documented role in disease and in mortality. Public education on the hazards of obesity has lead to development of a plethora of computerized aids for planning and tracking a balanced menu.

Hand held devices have been developed, which a user may carry to a supermarket, and may use to query a remote server as to the advisability of a specific purchase. Mobile phones having integral cameras have been suggested for this purpose, as the camera may be used to capture the barcode of a prepackaged food item. The barcode may then be transmitted via the Internet to a remote location, and compared to a database having nutritional data on a wide range of food products. Allergens may be detected in the food product using this method. Patent publications describing such handheld devices include: US 2002/0125313, JP 20030585550A2.

It is widely recognized that food consumption should be on the following sliding scale from among the various food groups: a majority of fruits and vegetables, a certain degree of whole grains and complex carbohydrates, a lesser degree of protein and a minimal amount of fats.

Dieters often need to record specific foods and portion sizes consumed over the course of a day, in order to track the daily caloric intake and then take note of the classification of items consumed of each food-group. Such daily tracking quickly becomes tedious. Therefore, hand-held devices have been developed to aid in tracking daily consumption; for instance patent publication KR 5009605A, U.S. Pat. Nos. 6,283,914 and 5,819,735, and EP Pat. No. 0976075 B1.

Diet-related Internet websites have also become popular. For instance, U.S. Pat. No. 7,247,023 to Peplinski provides a network-based diet plan, which determines the extent of the plan based on the user's relative need of weight loss. See also U.S. Publication No. 2007/0276618A1 to Mlynarski.

Diet-related Internet sites include websites which allow daily tracking of food consumption, and websites which offer set menus deemed to be nutritionally balanced. The websites which offer daily tracking tend to estimate the breakdown of the daily consumption and graphically display the breakdown of the various food-groups, such as in a pie-chart or bar graph. This allows a user to visually perceive whether he is on target in relation to the ideal breakdown of food groups. However, once a user has consumed an inordinate amount of a particularly unhealthy food, the website does not provide food-specific suggestions of how to correct the imbalance. A user visiting such a website will tend to become discouraged and overcome with helplessness, rather than encouraged when he notes how badly he has measured up on a specific day. A user may attend a business lunch or another function which will disrupt his diet plan. There is no solution to this problem of diet lapses or digressions, in a typical dieting website.

A typical diet website pays no attention to balancing the correct levels of trace minerals or vitamins in the diet plan. This can affect general health in the long term.

Another disadvantage of dieting websites which offer preplanned menus, lies in their being limited in terms of the number of menus made available. A typical website will provide 3-5 weekly menu plans, after which the menu becomes redundant and unappetizing. If we assume one such weekly menu will be vegetarian, and another one will contain items which do not appeal to the user or which are not readily available, a dieter will quickly become bored with these limited menus and will abandon them in favor of unhealthy alternatives.

The need exists for a computerized diet menu planning aid, which overcomes the above disadvantages, and automatically corrects a daily or weekly menu plan, for a lapse which occurred. The menu planning aid should provide an unlimited number of food choices, which prevents boredom and allows a user to adhere to the diet for several months or more. The menu planning aid should provide a menu which balances the diet to optimal levels of trace elements (vitamins and minerals).

The present invention provides these and other advantages, as will become apparent in the detailed description of the invention that follows.

### SUMMARY OF THE INVENTION

The present invention thus provides a method for computerized preparation of a nutritionally balanced daily food menu. The method comprises:
a) initiating a record of a new user, or recognizing a known user;
b) automatically retrieving pre-classified food items from a food item database, to form an initial daily menu,
c) displaying the initial daily menu to a user upon display means;
d) allowing a user to amend the initial daily menu;
e) calculating the concentration of specific nutrients present within the food items of the amended daily menu or present within food items of the initial daily menu;
f) comparing the nutrient concentrations calculated in step e), to predefined recommended nutrient concentrations, and detecting significant nutrient surpluses or nutrient deficiencies;
g) automatically balancing the daily food menu to eliminate the significant nutrient surpluses or nutrient deficiencies;
h) displaying the balanced daily food menu prepared in step g) as a final daily food menu;
i) optionally, repeating steps b)-h) one or more times, to form food menus for a plurality of days.

In one embodiment, the step of initiating a record of a new user, may comprise querying a user for his general health information and for his meal preferences, and saving the responses to the queries onto a computer-readable medium, for use in subsequent preparation of an initial daily menu. Queries pertaining to the general health information of a user may comprise one or more of the following: a user's weight, build, gender, exercise regimen, documented health issues and food allergies.

Queries pertaining to meal preferences of a user may comprise at least one of the following: a meal style, specific preferred food items, and specific disliked food items.

Step a) of recognizing a known user, may comprise retrieving from computer-readable memory, user data related to the general health information and meal preferences of a user, and using the retrieved data to prepare an initial daily menu for the user.

In some embodiments, the food item database of pre-classified food items comprises a plurality of food items which have been classified into known food groups, and the nutrient content has been estimated for the food items.

Step d) of allowing a user to amend the initial daily menu, may comprise allowing a user to perform one or more of the following acts: to adjust the portion size of a food item; to remove a food item; to replace a food item with another food item from the food item database; and to add a food item from the food item database.

Step e) of calculating the concentration of specific nutrients, may comprise determining one or more central nutrients present in high concentration within a food item, or determining the presence of a nutrient of nutritional importance, in a food item.

Step f) of comparing the nutrient concentrations to predefined recommended nutrient concentrations, may comprise:
i. detecting a nutrient gap comprised of a nutrient surplus or a nutrient deficiency,
ii. assigning a grade to a nutrient gap, wherein the grade reflects the weighted nutritional importance of the nutrient within a balanced menu, and the grade reflects the size of the gap;
iii. evaluating the grade of the nutrient gap, and comparing the grade to predefined grading values;

iv. receiving a decision of the necessity to balance the nutrient gap or to ignore the presence of the gap.

Step g) of automatically balancing the daily food menu, may comprise one or more of the following: adjusting the portion size of a food item; removing a food item from the menu; and replacing the food item with another food item from the food item database.

Step i) of repeating steps b)-h) one or more times may comprise repeating the steps to prepare a nutritionally balanced food menu for a period comprising one of the following: a week, two weeks or a month.

Step d) of allowing a user to amend the initial daily menu, may comprise allowing a user to enter food items consumed during a lapse which occurred in adherence to the daily menu, thereby allowing rebalancing of the remainder of the daily menu in steps e) to h).

The method of the invention may further comprise the step of allowing a recognized user to add new food items to the food item database, and performing automatic nutritional classification of the new food items.

The invention further provides a system for computerized preparation of a nutritionally balanced daily food menu. The system comprises:
i. computer associated peripherals;
ii. a processor interacting with the peripherals, the processor including a memory device, a driver; display means; the processor being in communication with the memory device, and being configured to:
   a. initiate a record of a new user, or recognize a known user;
   b. retrieve pre-classified food items from a food item database, to form an initial daily menu,
   c. display the initial daily menu to a user upon display means;
   d. allow a user to amend the initial daily menu;
   e. calculate the concentration of specific nutrients present within the food items of the amended daily menu or present within food items of the initial daily menu;
   f. compare the nutrient concentrations calculated in step e), to predefined recommended nutrient concentrations, and detect significant nutrient surpluses or nutrient deficiencies;
   g. balance the daily food menu to eliminate the significant nutrient surpluses or nutrient deficiencies;
   h. display the balanced daily food menu prepared in step g) as a final daily food menu;
   i. optionally, repeat steps b)-h) one or more times, to form food menus for a plurality of days.

In the system of the invention, the food item database may be stored on computer-readable storage medium upon a remote server. The remote server may be configured to allow a recognized user to access the food item database.

Optionally, a remote user is configured to send a user periodical updates to a food database, the updates comprising new pre-classified food items to be added to the food database.

Optionally in the system, the processing means is configured to allow a user to add new food items to the food item database. The new food items are classified nutritionally during their addition to the food item database.

The present invention additionally provides computer readable storage medium comprising software capable of:
a) initiating a record of a new user, or recognizing a known user;
b) automatically retrieving pre-classified food items from a food item database, to form an initial daily menu,
c) displaying the initial daily menu to a user upon display means;
d) allowing a user to amend the initial daily menu;
e) calculating the concentration of specific nutrients present within the food items of the amended daily menu or present within food items of the initial daily menu;
f) comparing the nutrient concentrations calculated in step e), to predefined recommended nutrient concentrations, and detecting significant nutrient surpluses or nutrient deficiencies;
g) automatically balancing the daily food menu to eliminate the significant nutrient surpluses or nutrient deficiencies;
h) displaying the balanced daily food menu prepared in step g) as a final daily food menu;
i) optionally, repeating steps b)-h) one or more times, to form food menus for a plurality of days.

In the computer readable storage medium of the invention, step a) of initiating a record of a new user, optionally comprises querying a user for his general health information and for his meal preferences, and saving the responses to the queries onto a computer-readable medium, for use in subsequent preparation of an initial daily menu.

In the computer readable storage medium of the invention, the food item database of pre-classified food items may comprise a plurality of food items which have been classified into known food groups, and the nutrient content has been estimated for the food items.

In the computer readable storage medium of the invention, step d) of allowing a user to amend the initial daily menu, may comprise allowing a user to perform one or more of the following acts: to adjust the portion size of a food item; to remove a food item; to replace the food item with another food item from the food item database, and to add another food item from the food item database.

In the computer readable storage medium of the invention, step f) of comparing the nutrient concentrations to predefined recommended nutrient concentrations, may comprise:
detecting a nutrient gap comprised of a nutrient surplus or a nutrient deficiency,
assigning a grade to a nutrient gap, wherein the grade reflects the weighted nutritional importance of the nutrient within a balanced menu, and the grade reflects the size of the gap;
evaluating the grade of the nutrient gap, and comparing the grade to predefined grading values;
receiving a decision of the necessity to balance the nutrient gap or to ignore the presence of the gap.

In the computer readable storage medium of the invention, step g) of automatically balancing the daily food menu, may comprise at least one of the following: adjusting the portion size of a food item; removing a food item from the menu; and replacing the food item with another food item from the food item database.

In the computer readable storage medium of the invention, step d) of allowing a user to amend the initial daily menu, may comprise allowing a user to enter food items consumed during a lapse which occurred in adherence to the daily menu, thereby allowing rebalancing of the remainder of the daily menu in steps e) to h).

### GLOSSARY

The term “nutrient” as used herein refers to an ingredient present in a food item, which may be assimilated by a human for growth, tissue replacement or for providing energy. The term “nutrient” includes “macronutrients” (such as carbohydrates, fat, saturated fat and proteins) and “micronutrients” (such as vitamins and minerals).

The terms “food product” or “food item” are used interchangeably herein to refer to anything edible, having one or more ingredients. The term refers as well to the product of a food recipe, and is meant to include food supplements (such as one or more vitamins or minerals in any final form).

The term “gap” as used herein in relation to a “nutritional gap”, refers to a quantative difference in value, between the recommended daily amount for a nutrient, and the actual amount of nutrient present in a daily menu. The recommended daily amount can be based, for example, on an RDA or a DRI value. The nutritional gap can be either positive or negative, indicating, respectively, a nutritional deficiency or a surplus.

The term “alternative food product” or “alternative food item” refers to a food product that can be used to replace another food product, in order to nutritionally balance a daily menu. The alternative food product will typically be another member of the macronutrient/micronutrient group as the original food product undergoing replacement, however the alternative food item typically overcomes a nutritional gap. Predetermined parameters qualify specific food items as proper alternatives for other food items.

The term “meal style” as used herein, refers to the type of meal preferred by an individual. For instance, one meal style would be a main course and side dishes, while another meal style would be a sandwich. A third meal style would be a large salad served as a main course.

The term “daily menu” as used herein refers to a set of food items listed at certain quantities, recommended for daily consumption by a user. The daily menu may optionally be divided into sub-groups such as breakfast, lunch, dinner, snacks, etc.

The term “initial daily menu” refers to a balanced daily menu displayed to a user for his approval or amendment.

The term “final daily menu” refers to a daily menu displayed to a user after any user changes (if any) have been entered, and after the menu has been rebalanced (if necessary), in response to such changes.

The term “food group” as used herein, relates to foods sharing similar nutritional properties and being part of the hierarchy of the food pyramid, such as cereal group, milk group, meat and protein group, fruit and vegetable group, fats and sweets group.

The term “computer-readable storage medium” refers to any type of medium to which data may be saved and later retrieved for handling, using a computer. Examples include, but are not limited to, a hard drive, floppy disk, CD, DVD, or flash memory.

The term “remote electronic device” refers to an electronic apparatus having processing means, and display means, which may be used to carry out the invention. Preferably, the device includes communication means as well. Non-limiting examples include: a personal computer, a PDA, a mobile phone, and a laptop computer.

### BRIEF DESCRIPTION OF THE DRAWINGS

For a better understanding of the invention, with regard to the embodiments described, reference is made to the accompanying drawings, in which:

FIG. 1A is a flowchart illustrating initiation of the process of the invention, and initial daily menu generation. FIG. 1B-1C are flowcharts showing how a user may amend an initial daily menu.

FIG. 2 is a flowchart describing the process for automatic nutritional balancing of a daily menu.

FIG. 3 is a flowchart describing the process for lowering a nutrient surplus in a daily menu.

FIG. 4 is a flowchart describing a process for correcting a nutrient deficiency present in an initial daily menu.

FIG. 5 is a flowchart describing the process in which a user adds of food items or recipes to the food item database.

### DETAILED DESCRIPTION OF THE INVENTION

In the following detailed description, numerous specific details are set forth in order to provide a thorough understanding of the present invention. There is no intention to limit the invention to the details of construction and the arrangement of the components set forth in the following description or illustrated in the drawings. The invention is capable of other embodiments or of being practiced or carried out in various ways. Also, it is to be understood that the phraseology and terminology employed herein are for the purpose of description and should not be regarded as limiting.

In general, the present invention pertains to a computerized diet menu aid, which provides a user with interactive menu planning. The invention may be provided to a user as software for use in a personal computer or another electronic device having a processor and a display. Alternatively, the invention may have the form of a network-based Internet website, which a user may access periodically to obtain menu planning

Advantages of the invention include: the computerized menu planning aid supplies detailed food-related suggestions which overcome specific incidents of digression from the planned menu. The invention accesses a continually expanding database of nutritionally pre-classified foods, which may be included in the menus suggested, thus providing an infinitely greater variety of foods and menus than other websites. These features are not previously known in the art. Moreover, the menu planning aid is interactive, allowing a user to remove or add foods according to preference, and allowing the user to control the portion size. The software automatically rebalances the menu if necessary, after user intervention in the menu has occurred. The invention additionally provides balancing of micronutrients. The invention is supported by software which recognizes a user's food preferences over time, and suggests future menus accordingly. These features transform the menu planning aid of the invention into a sophisticated diet tool, which a user can use to truly adhere to a weight-loss plan over a considerable length of time. The variety in the proposed menus, and the practical detailed suggestions which overcome incidents of digression, allow a user to persist in the weight-loss plan for several months, and to persist in keeping a nutritionally-balanced diet for an unlimited period of time.

The software of the invention, and the food item database, may be provided to individual users for operation on their personal computers or similar individually owned remote electronic devices (e.g. PDAs, mobile phones, laptops, etc.) Alternatively, the software of the invention and the food item database may be uploaded onto a remote server, which users may access via the Internet. The user may utilize his personal computer or other remote electronic device to communicate with the server, and to receive a display of an initial daily menu and a final balanced daily menu, upon display means associated with his remote electronic device. The user's remote electronic device (personal computer, PDA, mobile phone or laptop) may be equipped with any computer-associated peripherals known in the art, such as a mouse, a display screen, a keyboard, etc.

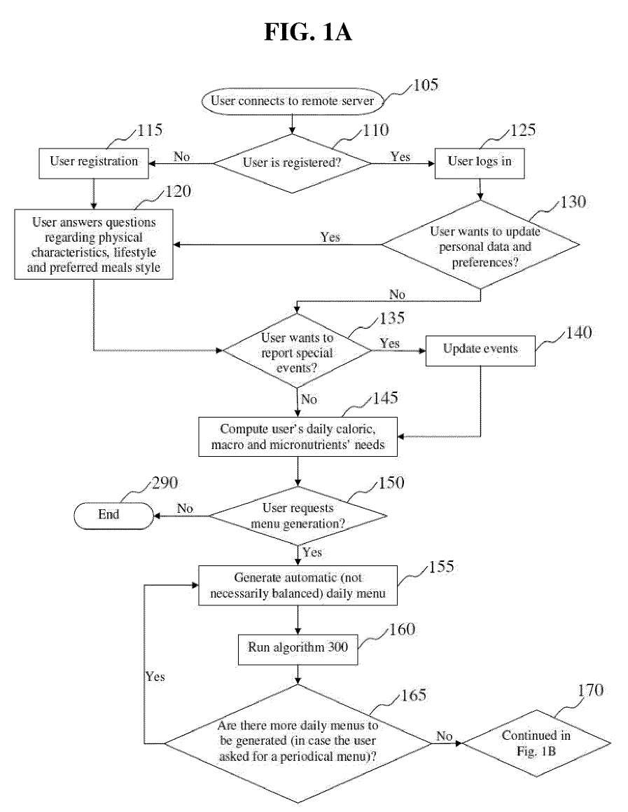

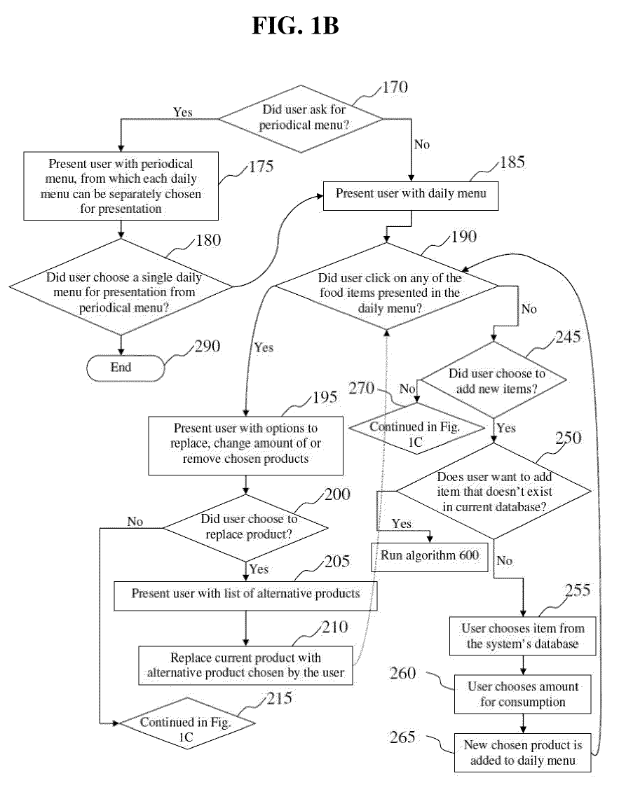

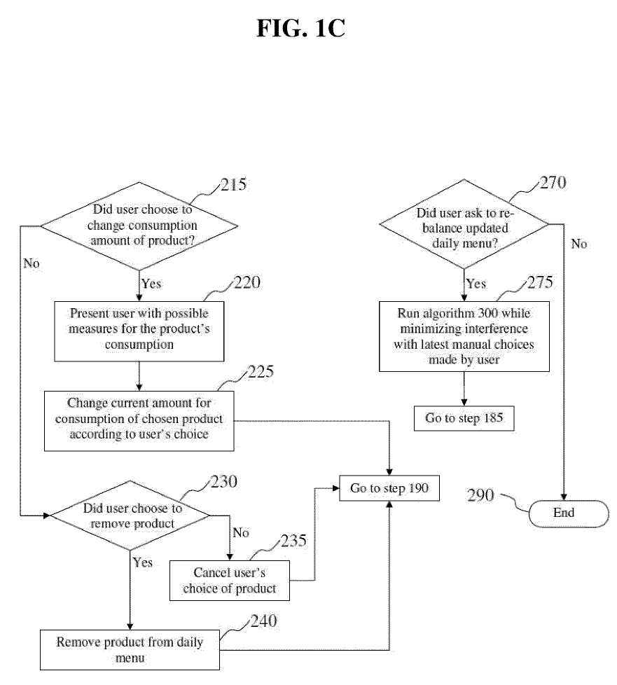

Referring to FIG. 1A, a flowchart is shown describing a user's initial or subsequent access of a website according to the principles of the invention. FIG. 1 additionally describes initial menu generation using software of the invention, defined by an algorithm referred to herein as “algorithm 100”.

In block 105, a user accesses the website, using a personal computer, a mobile phone, a PDA, or any electronic device capable of communicating with a remote server which supports the website. The server has been previously uploaded with the software of the invention.

In block 110, the software verifies whether the user is registered or not.

In block 115, if the user is not registered, he is prompted to register.

In block 120, he is asked to answer a series of questions regarding his physical characteristics (e.g. age, height, weight, gender etc.) and his lifestyle (e.g. eating habits, workplace, sensitivity to foods, propensity to drink alcohol, specific food products and food groups that the user likes and dislikes). The user is asked about his preferred meal style (for example, does the user prefer a main course+side dishes for lunch or does he prefer a sandwich).

In block 145, based on the user's physical characteristics and lifestyle habits, the software will compute the user's daily caloric needs and his daily macronutrients' needs (total and saturated fat, proteins, carbohydrates). The software will additionally compute his daily micronutrient needs (e.g. iron, vitamin B6, vitamin B12, vitamin C, vitamin E, vitamin A, folate, calcium, thiamin, niacin, riboflavin).

In block 130, if the user is registered, he may change the answers to questions previously asked during the registration phase. For instance, he may change his preferred style of meals.

In block 135, the user can specify any special events (e.g. an invitation to an upcoming wedding, a vacation, a temporary illness that occurred, etc.). Events may also be reported after initial user registration.

In block 140, if special events are reported, the software will record the update as a short term activity (relevant only for a limited period of time).

In block 150, the user can request generation of a new menu, which can extend over the course of a day, a week or any other period.

In block 155, the software of the invention will automatically generate a daily menu by selecting food products from a central database, into meals and acceptable snacks. One or both of the following criteria are utilized in selection of food items for the menu: the food item's nutritional suitability to the meal, and the user's personal preference, as recently inputted or as retrieved from memory storage of any form.

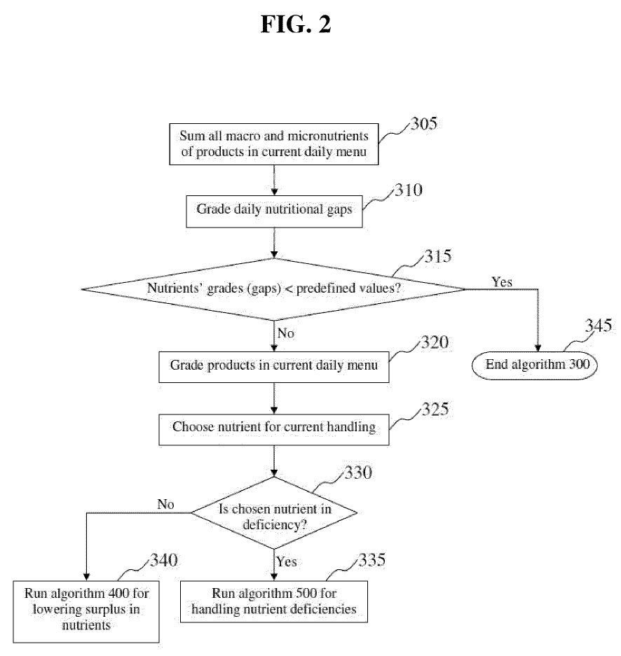

Once a complete daily menu is generated, it will be nutritionally balanced utilizing the algorithm herein-below termed “algorithm 300” and described in relation to FIG. 2.

In block 165, a daily menu will be generated for each day included in the period requested.

Referring now to FIG. 1B, block 185, the resulting initial balanced daily menu will be presented to the user.

In block 175, if a periodical menu was requested, the user will be presented with a periodical representation from which any single day included in the presented period can be chosen separately for reviewing (block 180).

Each daily menu is interactive, so that the user can ask to change its composition. In block 190, the user can select any food product included in the daily menu, for example (but not limited to) by clicking on it.

In block 195 (depicted in the lower left side of FIG. 1B), once a product is selected, the user will be presented with the option to replace the item, to change the item's portion size, or to remove the item completely from the menu.

In blocks 200-205, if the user chooses to replace the product, a list of alternative products will be presented from which an alternative product can be chosen to replace the current selected item.

A user may also add food items from the food item database, to the initial daily menu, to suit his preferences. For instance, a user may add a small amount of a “forbidden” food to the daily menu (a food item which has little or no nutritional value). The software of the invention will proceed to balance the menu to overcome the nutritional imbalance, as described herein below in relation to FIG. 2-4.

Referring briefly to FIG. 1C, block 215, if the user chooses to change the amount for consumption of a product, a list of possible measures for the requested product will be presented (block 220), from which the user can choose the type of a measure and its amount, after which the newly selected amount will be updated for the chosen product (block 225).

In block 230, if the user chooses to remove the product, it will be erased from the daily menu (block 240).

The invention thus allows a user considerable leeway in amending the daily menu to suit his preferences. As the software of the invention will proceed to balance this initial daily menu including any and all user amendments, a user may, for instance, add “forbidden” foods or may replace suggested foods with those food items more readily available to him. Such a large degree of latitude is not found in other menu planning aids, and guarantees success in following the menu plan for longer periods of time.

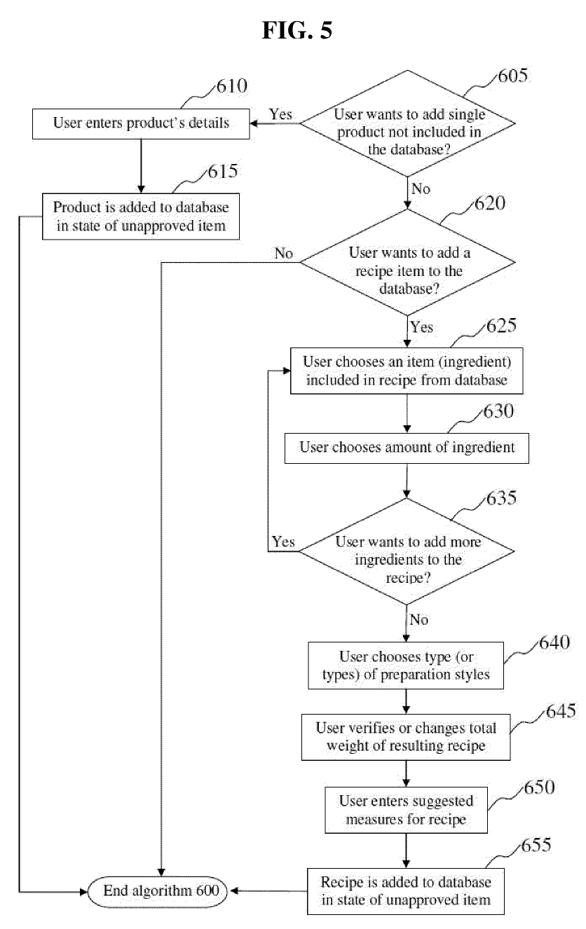

Referring back now to FIG. 1B, lower right branch of the flowchart. In blocks 245-250, the user may add a new item to the daily menu. New items are food products not originally included in the daily menu presented to the user. The user can either add an item from the current database (block 255), or add an item not included in the system's database, in which case “algorithm 600” (described herein in relation to FIG. 5) will run for adding such an item to the database. The option of adding a food item (or a recipe) according to algorithm 600 to the system's database is also available after a user initially logs on to the website.

In block 260, if the user chooses a product from the current database, he also chooses the portion size for consumption. In block 265, the desired amount of the product is added to the daily menu.

Referring to FIG. 1C, block 270, the system will keep record of all changes requested by the user for this day. Once all changes are done, the user can request rebalancing of the daily menu. In block 275, “Algorithm 300” for balancing the menu will run (described herein in relation to FIG. 2). The algorithm acts to rebalance the menu with minimum change to the user requests for that specific menu. The resulting balanced menu will be presented again to the user (block 185, FIG. 1B), and further changes can be conducted until the user is satisfied with the final result.

Referring to FIG. 2, a flowchart of “Algorithm 300” is depicted, describing the algorithm for automatic nutritionally balancing of a daily menu. In block 305, the software of the invention sums all the macronutrients and micronutrients in the initial unbalanced daily menu. The macronutrients are summed based upon their content concentration in food items included in the daily menu (i.e. the total amount of carbohydrates, of protein, etc. present in the daily menu).

The invention provides a user with a menu which takes into account the correct recommended levels of trace minerals and vitamins (termed “micronutrients”). In contrast, prior art menu planning aids do not detect or adjust for such details, rather they pertain only to general breakdown of foods into the various food groups.

In block 310, the software grades the nutritional gaps between the specific macronutrient and micronutrient values presented in the unbalanced daily menu, and the ideal recommended daily nutritional values. Grading of the nutritional gaps is based on the size of the gap, and on a predefined weighted value indicating the importance of each specific nutrient. Positive gap values may be used to indicate a nutrient deficiency, while negative values may indicate a nutrient surplus.

In block 315, the grade of a nutrient gap is compared to a predefined grading value, and if the grade is deemed insignificant, the initially presented daily menu is deemed nutritionally balanced. In block 345, “Algorithm 300” for menu balancing is terminated.

Alternatively, in block 320, if the daily menu is deemed nutritionally unbalanced, then the contribution of each food product, to formation of the gaps, is estimated from the initial daily menu. Grading is once again based on both the contribution of each nutrient in the food product to the nutrient's overall daily gap, and on a predefined value indicating the importance of the specific nutrient.

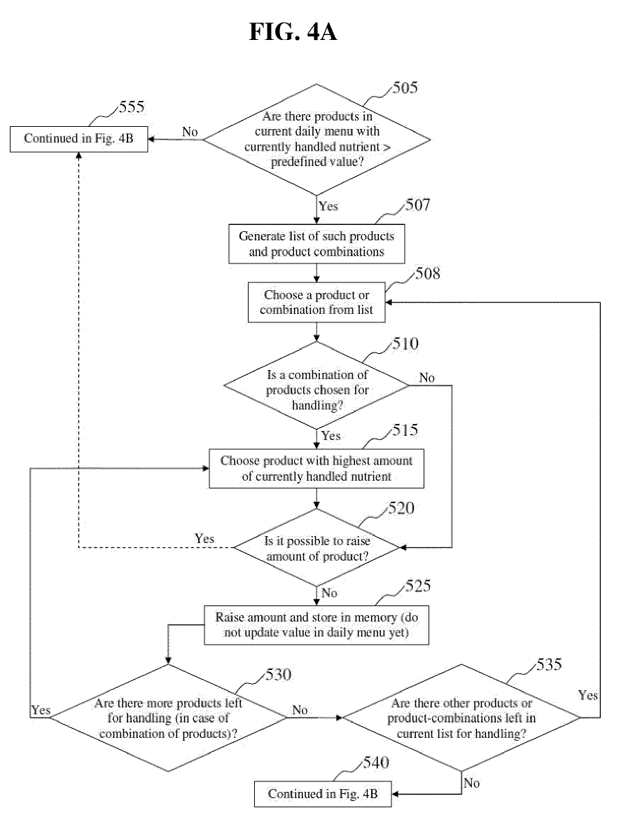

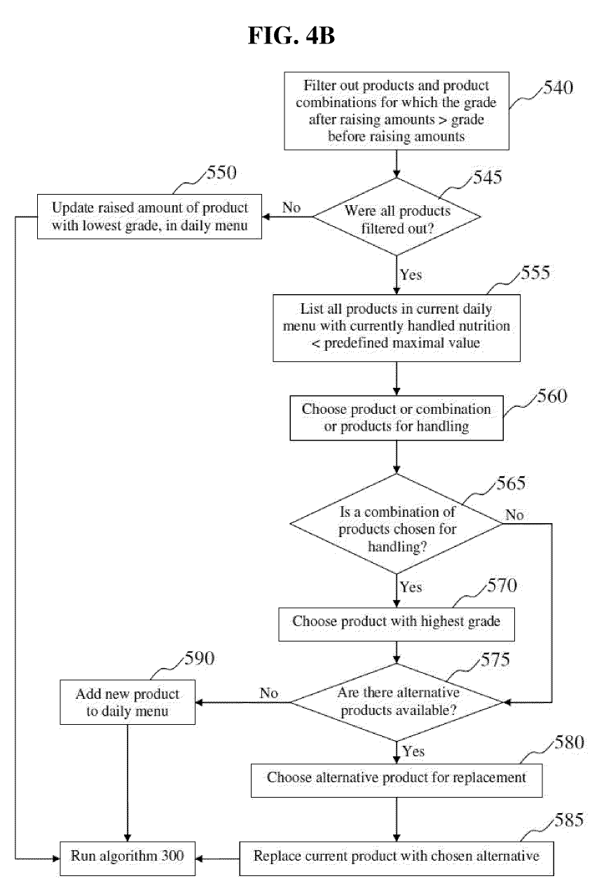

In block 325, the nutrient with the highest gap grade is automatically chosen for handling, for reduction of the gap. The gap may represent a nutrient deficiency or a surplus. In blocks 330-335, if the nutrient chosen for handling is in deficiency, the system will run “Algorithm 500” for balancing deficiencies (described herein-below in relation to FIG. 4A).

In block 340, is the nutrient with the highest gap grade is in surplus, the software will automatically run “Algorithm 400” for lowering a nutrient surplus.

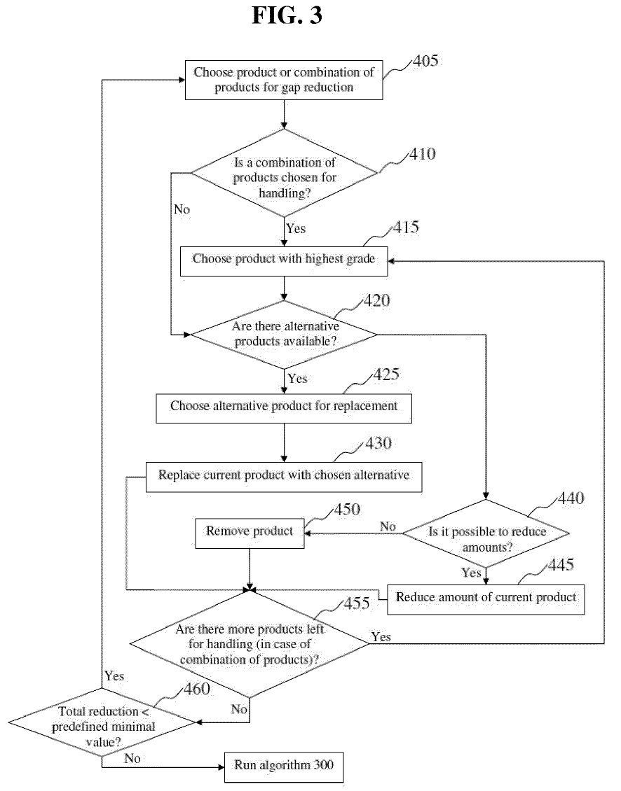

Referring to FIG. 3, a flowchart of “Algorithm 400” for lowering a nutrient surplus is depicted. In block 405, the algorithm initially determines the most nutritionally significant surplus, based on the nutrient gap grading. The software checks which food products, present the initial daily menu, contribute to the gap of the currently handled nutrient.

In block 410, the software selects a specific product or a combination of two or more products, which need to be handled to reduce the gap. The product or combination of products to handle, is chosen according to a set of rules that take into account at least one of the following: the contribution of the product/s to the current nutritional gap, the grade of the products influenced by their contribution to gaps of other nutrients, the number of products in a combination of several products. Additional rules may be included.

In block 415, if a combination of several food products is chosen for handling, the product with the highest grade will be handled first.

Optionally, the selection of the order of handling food surpluses will not be limited only to the food product's grade. Additional parameters may be taken into account, such as whether the user has recently chosen to make changes to the food product.

In block 420, once a specific food product is chosen for handling, the software will check for availability of alternative food products. Alternative food products can be chosen as one of: a predefined set of alternative products for each products, products that belong to the same category of meal and subcategories of meals, products that belong to the same food groups (defined in the food product database), or any other set of rules for choosing a set of specific alternative products for any specific food products.

In block 425, the software checks among the available alternative products for those products that reduce the amount of the currently handled nutrient by more than a predefined percentage value. An alternative product for replacement of current product is chosen according to a combination of both the product's amount of reduction of currently handles nutrient, and the product's grade, influenced by its contribution to gaps in other nutrients. In block 430, the product to be replaced, is erased from the daily menu and the chosen alternative product is added in its place.

In block 440, if it is impossible to replace the current product with a proper alternative product (according to the set of rules described above), the system will check if it is possible to reduce the amount of recommended consumption of the product in the initial daily menu. In such case, a new recommended portion size will be updated for that specific product (block 445).

In block 450, if the amount of the specific food product cannot be lowered, the product will be removed entirely from the daily menu.

In block 455, if a combination of more than one product is currently being handled, the process described above (of finding alternative products \ reducing amounts \ removal of products), is repeated for every food product included in the combination.

In block 460, once all products in a specific combination have been handled, the total reduction of the currently handled nutrient will be re-evaluated. If the reduction is lower than a predefined minimal value, the process of choosing alternative products \ reduction\ removal is re-iterated for the products of the updated combination. This process is repeated until the amount of the handled nutrient in the current combination is lower than a predefined minimal value (i.e. the reduction of the nutrient is higher than the predefined minimal value).

In certain embodiments, the order of the steps described in Algorithm 400, (FIG. 3) may be different. Instead of first trying to replace the product, then trying to reduce its quantity, then removing it, one can envision that the software may first try to reduce the product quantity, and then try to replace the product with an alternative product, and only then, if necessary, remove the product.

Referring to FIG. 4A, a flowchart is shown of “Algorithm 500” for correcting a nutrient deficiency present in an initial daily menu.

In block 505, the algorithm initially detects which food items in the initial daily menu have a deficiency of a specific nutrient. A deficiency is defined being below a predetermined threshold value. If several nutrients are determined to be in deficit, the software may begin with the most significant deficiency, according to predefined values. Afterwards, additional nutrients may be handled and their deficiencies corrected in the daily menu, until the daily menu is deemed to be balanced.

The software may detect a combination of two or more food products that can be utilized to correct for the nutrient deficiency, and will choose to handle the combination in a single instance. In block 507, a list of all such products or product-combinations is generated.

In block 508, one product or a combination of products is chosen from the list, either arbitrarily or according to a predefined set of rules.

In block 510, if a combination of products is chosen, the food product considered to contribute most significantly to the deficiency is selected for handling (block 515). Afterwards, the product with the closest amount of the same nutrient will be handled and so on.

In block 520, the software determines whether the portion size of the selected product may be raised in order to overcome the deficiency (gap), without passing a recommended amount for daily consumption.

In block 525, the new amount (portion size) is stored in memory, but in one embodiment, not yet updated in the current daily menu.

In block 530, if a combination of more than one product is handled, the amount of each product is first raised separately, the increased portion sizes are retrieved from temporary memory, and the gap is re-evaluated to determine whether a deficiency still exists and to what extent.

In block 535, the process of portion size increase, is repeated for all products, as described above.

Referring to FIG. 4B, block 540, the nutritional grade of each product or combination of products, is compared to the grade before the product amount was raised. This determines whether the increase in portion size had a positive or negative overall nutritional effect on the daily menu, in terms of nutritional balancing of the menu. If the updated nutritional grade is deemed worse than the grade before the raise of the amount for consumption, then the product or combination of products is filtered out, namely removed entirely from the menu.

In block 545, the software detects whether all products having negative grades were removed (filtered) from the menu.

In block 550, the software detects products or combinations of products with passing grades, indicating an improvement in the nutritional balancing of the daily menu. The increased portion sizes of these products are then saved in the daily menu, which is considered updated. (In block 550, “low grades” are considered nutritious, and therefore advantageous grades, while “high grades” are considered unbalanced nutritionally.)

When estimating the nutritional grade of a combination of products, a summation is performed of the grades of all products included in the combination.

One example of use of a combination of food products is, for instance, when a calcium deficiency is detected. While the amount of milk in the daily menu may be raised to attempt to overcome this, most probably the amount of cheese or yogurt will be raised as well, as a more efficient means to overcome the deficiency. Thus the combination of “milk+yogurt/cheese” was used to balance the initial daily menu.

A nutrient deficiency may be detected, which cannot be overcome by raising the portion size of food items present in the initial menu. The software will then check for food items which should be replaced with alternative products. In block 555, the software checks the initial menu for food items which do not contain the currently handled nutrient, or which contain the nutrient at a concentration lower than a predefined value. In block 560, one of these food items is selected for handling according to one or more of the following: the concentration they include of the nutrient in deficiency, according to their grade, according to the number of products included in a combination of products. Additional rules may be employed to select the food item to be replaced first. In block 570, if a combination of several products is chosen for handling, the product with the highest grade is handled first.

Referring to block 575, once a specific food item is chosen for replacement handling, the software will check the availability of alternative food products. Alternative food products can be chosen as one of: a predefined set of alternative products for each products, products that belong to the same category of meal and subcategories of meals, products that belong to the same food groups (defined in the food product's database), or any other set of rules for choosing a set of specific alternative products for any specific food products.

From the set of available alternative products, the software will check for products that possess the currently handled nutrient at an amount higher than a predefined percentage value.

In block 580, an alternative food item is chosen based on both the effect achieved on the concentration of the currently handled nutrient, and on the alternate food item's grade, namely its contribution to gaps of other nutrients.

In block 585, the initial food item (to be replaced) is erased from the daily menu and the alternative product selected, is added in its place 585.

In block 590, additional food items may be added to the daily menu in order to correct a nutritional gap. This may not necessitate removal or replacement of initial food items. Items may be selected from the food item database based on one of the following: the amount of a currently handled nutrient, their classification of preferred meals and sub-categories of meals, their belonging to a specific food group, the presence of other specific items in the daily menu (which have been removed, or their amount has been reduced), compliance with a user's preferences, and product's grade.

In relation to FIGS. 3 and 4, the order of steps described in the relevant flowcharts, may be reversed. Instead of first trying to raise the amount of a consumed product, then trying to replace a product, and then adding a new product; the software instead may first replace the product with an alternative product, then try to raise the quantity, and then add a new product.

One advantage of the invention is that it allows a user to correct for a lapse that occurred on a specific day, in which the user digressed from the planned diet menu.

In other computerized dieting aids known in the art, a user is unable to receive food-specific advice that would allow him to overcome the lapse.

In contrast, a user may utilize the invention to input relatively unhealthy (or large portion sizes of) food items already consumed not in accordance with the previously planned daily menu. He may then request rebalancing of the daily menu, to adjust for these lapses. The daily menu will be adjusted so that the remainder of the food items consumed that day are, for instance, of small portion sizes, and contain nutrients that were absent in the foods already consumed.

The ability to correct for diet lapses prevents a user from becoming discouraged with his lack of self-control, and thus allows him to continue to adhere to the diet for considerably longer periods than prior art diet aids. The rebalanced diet generally overcomes the lapse that occurred, so that weight loss or weight maintenance continues.

Refer now back to FIG. 1B, to illustrate how a user may enter a lapse which occurred and obtain a rebalanced menu to overcome the lapse. In block 185 (right-hand branch of flowchart), the user is presented with a daily menu. In block 190 a user may click on food items listed in the menu, which he did not consume. In blocks 195-215 (at left), a user replaces the items with those food items he did actually consume, or he may raise the portion size to reflect the amount he ate in reality. The software of the invention will then rebalance the menu, as illustrated in FIG. 1C through FIG. 4.

A user may know in advance when he will be forced to deviate from the menu plan, such as during a scheduled event he is invited to, where he will not have control over the food served. He may then utilize the invention to input the foods he estimates he will consume. He may then receive a new rebalanced menu, which may adjust the portion sizes to recommended sizes. Additionally, the invention will “thin out” and rebalance the remaining meals planned for that day, to overcome the calorie-rich scheduled event meal. Referring now back to FIG. 1A, block 135 (at center), a recognized user may report a scheduled event which will be updated (block 140). The software will continue to rebalance the daily menu, as illustrated in FIG. 1B through FIG. 4.

One advantage of the invention lies in its association with a continually expanding database of nutritionally pre-classified food items, which may be included in the menus suggested, thus providing an infinitely greater variety of foods and menus than other menu-planning aids. This allows a user to adhere to the menu plan for a considerable length of time without becoming bored by repetition of the food items in the menu.

Food items may be added to the database by a recognized user, or by a system administrator maintaining the database. The database may be provided to a user upon computer-readable storage medium (such as a CD), and the user may obtain periodic updates prepared at a remote location by a system administrator. The user may also provide new food items of interest, which will then be nutritionally classified and added to the database.

Alternatively, the food database may be saved on a remote server which the user may access. A recognized user is allowed to provide new food items of interest, which will then be nutritionally classified and added to the database. A system administrator will similarly add new food items periodically, thus expanding the database and adding to the variety of the menu.

Referring to FIG. 5, a flowchart of is shown of “Algorithm 600” illustrating the steps in which a user adds new food items or recipes to the food item database. In block 605, a user indicates his interest in adding a single new food item to the database.

In block 610, the user will enter a variety of details related to the food item. Some of these details are mandatory and some are optional. Details may include (but are not limited to): the name of the food product, the manufacturer (in case of a prepackaged food item), the suggested food-groups to which the food item belongs, the nutritional values of the food item, the measures in which it may be consumed.

In block 615, after the user has provided the necessary details, the product is added to the system's database in a state of an “unapproved item”, meaning the item may be used by the user. The “unapproved” food item but will not be presented to other users until a system manager approves inclusion of the food item in the database. The system manager may decide not to allow addition of the food item to the database. He will then flag the item to prevent its inclusion in menus prepared for the user that suggested the food item.

In block 620, the user may choose to add a recipe to the database. In blocks 625 and 630, the user selects ingredients from the system's database, and enters the appropriate amounts. In block 635, when all ingredients have been entered, the user selects the type of preparation suggested in the recipe (block 640), such as: baking, boiling, cooking, frying and smoking. More than one preparation method may be chosen.

The software will compute the total estimated weight of the final prepared food. This may be accomplished, for instance, by adding the weights of the ingredients and optionally by adjusting the estimation based on the method of preparation. The estimated weight of the food is then displayed to the user.

In block 645, the user may verify the total weight of the resultant food, or may change the total weight.

In block 650, the user is requested to enter suggested measures for consumption of the resultant food. In block 655, the food item and the recipe are added the system's database as an unapproved item (similar to the status described in block 615). The system administrator may then accept or reject the food or recipe for use in the database.

In summary, the present invention thus provides a computerized interactive diet aid which allows a user to plan daily or weekly nutritionally balanced menus, based on an endless variety of food items from a constantly updated food item database. The interactive nature of the software allows a user to select only foods of interest, and thus to adhere to the diet plan for considerable time. The invention allows a user to rebalance the menu when incidents of digression from the planned menu have occurred This allows the user to overcome such lapses, and continue with a nutritional plan without becoming discouraged. The menus are balanced for micronutrients (minerals and vitamins) as well as for macronutrients.

Having described the invention with regard to certain specific embodiments thereof, it is to be understood that the description is not meant as a limitation, as further modifications will now become apparent to those skilled in the art, and it is intended to cover such modifications as are within the scope of the appended claims.

1. A method for computerized preparation of a nutritionally balanced daily food menu, said method comprising:
a) initiating a record of a new user, or recognizing a known user;
b) automatically retrieving pre-classified food items from a food item database, to form an initial daily menu,
c) displaying said initial daily menu to a user upon display means;
d) allowing a user to amend said initial daily menu;
e) calculating the concentration of specific nutrients present within said food items of said amended daily menu or present within food items of said initial daily menu;
f) comparing said nutrient concentrations calculated in step e), to predefined recommended nutrient concentrations, and detecting significant nutrient surpluses or nutrient deficiencies;
g) automatically balancing said daily food menu to eliminate said significant nutrient surpluses or nutrient deficiencies;
h) displaying said balanced daily food menu prepared in step g) as a final daily food menu;
i) optionally, repeating steps b)-h) one or more times, to form food menus for a plurality of days.

2. The method of claim 1, wherein said step a) of initiating a record of a new user, comprises querying a user for his general health information and for his meal preferences, and saving the responses to said queries onto a computer-readable medium, for use in subsequent preparation of an initial daily menu.

3. The method of claim 2, wherein said general health information of a user comprises at least one of the following: a user's weight, build, gender, exercise regimen, documented health issues and food allergies.

4. The method of claim 2, wherein said meal preferences comprise at least one of the following: a meal style, specific preferred food items, and specific disliked food items.

5. The method of claim 1, wherein said step a) of recognizing a known user, comprises retrieving from computer-readable memory, user data related to the general health information and meal preferences of a user, and using said retrieved data to prepare an initial daily menu for said user.

6. The method of claim 1, wherein said food item database of pre-classified food items comprises a plurality of food items which have been classified into known food groups, and the nutrient content has been estimated for said food items.

7. The method of claim 1, wherein said step d) of allowing a user to amend said initial daily menu, comprises allowing a user to perform one or more of the following acts: to adjust the portion size of a food item; to remove a food item; to replace a food item with another food item from said food item database; and to add a food item from said food item database.

8. The method of claim 1, wherein said step e) of calculating the concentration of specific nutrients, comprises determining one or more central nutrients present in high concentration within a food item, or determining the presence of a nutrient of nutritional importance, in a food item.

9. The method of claim 1, wherein said step f) of comparing said nutrient concentrations to predefined recommended nutrient concentrations, comprises:
detecting a nutrient gap comprised of a nutrient surplus or a nutrient deficiency,
assigning a grade to a nutrient gap, wherein said grade reflects the weighted nutritional importance of said nutrient within a balanced menu, and said grade reflects the size of said gap;
evaluating the grade of said nutrient gap, and comparing said grade to predefined grading values;
receiving a decision of the necessity to balance said nutrient gap or to ignore the presence of said gap.

10. The method of claim 1, wherein said step g) of automatically balancing said daily food menu, comprises at least one of the following: adjusting the portion size of a food item; removing a food item from the menu; and replacing said food item with another food item from said food item database.

11. The method of claim 1, wherein said step i) of repeating steps b)-h) one or more times comprises repeating said steps to prepare a nutritionally balanced food menu for a period comprising one of the following: a week, two weeks or a month.

12. The method of claim 1, wherein said step d) of allowing a user to amend said initial daily menu, comprises allowing a user to enter food items consumed during a lapse which occurred in adherence to said daily menu, thereby allowing rebalancing of the remainder of said daily menu in steps e) to h).

13. The method of claim 1, further comprising the step of allowing a recognized user to add new food items to said food item database, and performing automatic nutritional classification of said new food items.

14. The method of claim 1, further comprising the step of providing a server in communication with a remote electronic device of a user, said server performing steps a)-i) of said method, wherein said server communicates with said remote electronic device to display said initial daily menu and said balanced daily food menu on display means associated with said remote electronic device; and said remote electronic device.

15. A system for computerized preparation of a nutritionally balanced daily food menu, comprising:
i. computer associated peripherals;
ii. a processor interacting with said peripherals, said processor including a memory device, a driver; display means; said processor being in communication with said memory device, and being configured to:
a. initiate a record of a new user, or recognize a known user;
b. retrieve pre-classified food items from a food item database, to form an initial daily menu,
c. display said initial daily menu to a user upon display means;
d. allow a user to amend said initial daily menu;
e. calculate the concentration of specific nutrients present within said food items of said amended daily menu or present within food items of said initial daily menu;
f. compare said nutrient concentrations calculated in step e), to predefined recommended nutrient concentrations, and detect significant nutrient surpluses or nutrient deficiencies;
g. balance said daily food menu to eliminate said significant nutrient surpluses or nutrient deficiencies;
h. display said balanced daily food menu prepared in step g) as a final daily food menu;
i. optionally, repeat steps b)-h) one or more times, to form food menus for a plurality of days.

16. The system of claim 15, wherein said food item database is stored on computer-readable storage medium upon a remote server.

17. The system of claim 16, wherein said remote server is configured to allow a recognized user to access said food item database.

18. The system of claim 15, wherein a remote user is configured to send a user periodical updates to a food database, said updates comprising new pre-classified food items to be added to said food database.

19. The system of claim 15, wherein said processing means is further configured to allow a user to add new food items to said food item database.

20. The system of claim 19, wherein said new food items are classified nutritionally during their addition to the food item database.

21. The system of claim 15, wherein said system utilizes a server in communication with a remote electronic device of a user, wherein said server is configured to perform steps a)-i) and to communicate said initial daily menu and said final daily food menu to said remote electronic device of said user, for display upon display means associated with said remote electronic device; and wherein said remote electronic device may be utilized to amend said daily menu and to communicate with said server.

22. Computer readable storage medium comprising software capable of:
a) initiating a record of a new user, or recognizing a known user;
b) automatically retrieving pre-classified food items from a food item database, to form an initial daily menu,
c) displaying said initial daily menu to a user upon display means;
d) allowing a user to amend said initial daily menu;
e) calculating the concentration of specific nutrients present within said food items of said amended daily menu or present within food items of said initial daily menu;
f) comparing said nutrient concentrations calculated in step e), to predefined recommended nutrient concentrations, and detecting significant nutrient surpluses or nutrient deficiencies;
g) automatically balancing said daily food menu to eliminate said significant nutrient surpluses or nutrient deficiencies;
h) displaying said balanced daily food menu prepared in step g) as a final daily food menu;
i) optionally, repeating steps b)-h) one or more times, to form food menus for a plurality of days.
